(19) United States
(12) Patent Application Publication
(10) Pub. No.: US 2018/0035693 A1
(43) Pub. Date: Feb. 8, 2018

(54) COATED FEED COMPOSITION FOR LACTATING RUMINANTS AND METHODS FOR MAKING AND USING THE FEED COMPOSITION

(71) Applicant: Benemilk Oy, Raisio (FI)

(72) Inventors: Feng Wan, Issaquah, WA (US); Merja Birgitta Holma, Hinnerjoki (FI); James Edward Nocek, Auburn, NY (US); Timothy Martin Londergan, Seattle, WA (US); Jayesh Ramesh Bellare, Mumbai (IN)

(73) Assignee: Benemilk Oy, Raisio (FI)

(21) Appl. No.: 15/504,642

(22) PCT Filed: Aug. 20, 2014
(86) PCT No.: PCT/US14/51825

§ 371 Date: Feb. 16, 2017

(51) Int. Cl. A23K 20/158; A23K 20/163; A23K 50/10; A23K 10/20; A23K 10/30; A23K 40/35; A23K 20/147; A23K 20/174

(52) U.S. Cl. CPC A23K 20/158; A23K 20/147; A23K 20/163; A23K 20/174; A23K 10/20; A23K 10/30; A23K 40/35; A23K 50/10

(57) ABSTRACT

A feed composition for ruminants may include feed particles of a nutritional component that are at least partially coated with a saturated fatty acid coating such that ingestion of the feed by lactating ruminants may provide for an increase in the amount of milk produced by the ruminant, and/or an increase in the fat content of the milk produced.

### BACKGROUND

Increasing milk production and improving milk quality have always been primary goals when feeding lactating dairy animals, such as dairy cows. Depending on the animal, the feed components may vary considerably. For example, ruminants are able to digest fibrous plant based foods, or roughage, that are indigestible to non-ruminants. Ruminants may include lactating animals such as, for example, cattle, goats, sheep, and dairy cows. Illustrative types of roughage include hay, grass silage, corn silage, straw and pasture, as well as various whole grain/leguminous silages and other fodders.

For efficient milk production, ruminants may also be given, in addition to roughage, a feed concentrate that may include energy components (that is, carbohydrates and fats), protein components, minerals, micronutrients, and vitamins. Some examples of common feed items include grain feeds (such as corn, oats, barley, and wheat), vegetable oilseed crushes or meal (rapeseed), and soybeans. A large variety of byproducts from food industries may also be used.

Although milk production of cows has increased over time, the degree of utilization of feed has essentially not improved. The same amount of energy intake per kilogram of milk is needed now as was needed decades ago. When the utilization of energy becomes more effective, milk production may increase, and the concentration of protein and fat in the milk may increase.

Attempts to increase milk fat content tend to lower milk production and/or protein content, and result in other undesired effects, such as increased trans fatty acid levels, on the fatty acid profile of the milk fat. Therefore, a need exists for new feed compositions and methods that can increase milk production and/or increase levels of milk fat in milk produced by ruminants.

### SUMMARY

To provide for an increase in the amount of milk produced by a ruminant, and/or an increase in the fat content of the milk produced, the ruminant may be provided with a feed composition that includes feed particles of a nutritional component coated with a saturated fatty acid coating.

In an embodiment, a feed composition for ruminants includes a feed particle comprising a nutritional component, and a coating on at least a portion of the feed particle, wherein the coating comprises a saturated fatty acid component.

In an embodiment, a method of producing a coated feed particle for ruminants includes coating at least a portion of a nutritional feed component with a coating material comprising a saturated fatty acid component.

In an embodiment, a method is provided for increasing at least one of an amount of milk produced by a lactating ruminant and a milk fat content in the milk produced by the lactating ruminant. The method includes feeding the lactating ruminant a feed particle that includes a nutritional component and a coating on at least a portion of the feed particle, wherein the coating includes a saturated fatty acid component.

### BRIEF DESCRIPTION OF THE FIGURES

FIG. 1 depicts a representation of coated feed particles according to embodiments.

FIG. 2 depicts a coated feed particle having multiple coatings according to an embodiment.

FIG. 3 depicts a representative feed mixture including coated feed particles according to an embodiment.

FIG. 4 depicts a general representation of a method for producing coated feed particles and feed pellets according to an embodiment.

### DETAILED DESCRIPTION

With respect to the description presented herein, a “ruminant” is a class of mammal with a multiple chamber stomach that gives the animal an ability to digest cellulose-based food by softening it within the first chamber (rumen) of the stomach and regurgitating the semi-digested mass. The regurgitate, known as cud, is then chewed again by the ruminant. Specific examples of ruminants include, but are not limited to, cattle, bison, buffaloes, yaks, camels, llamas, giraffes, deer, pronghorns, antelopes, sheep, and goats. The milk produced by ruminants is widely used in a variety of dairy-based products. Dairy cows are of considerable commercial significance for the production of milk and processed dairy products such as, for example, yogurt, cheese, whey, and ice cream.

The formation of milk in the mammary gland is a complex enzymatic process regulated by hormones, requiring a significant amount of ATP energy at the cell level, as well as suitable starting materials and enzymes. The main components of milk, that is, lactose, protein, and fat, are synthesized in the cells of the udder. Glucose availability in the mammary gland, as well as the availability of amino acids has typically been regarded as the main limiting factor in milk production.

Microbes in the rumen ferment carbohydrates of the feed to acetic acid, butyric acid and propionic acid, with propionic acid generally being the most important precursor of glucose. These acids may be absorbed through the rumen wall, and transported to the liver where they are converted to useful nutrients. Acetate may be consumed in the liver to produce energy and may also be converted to longer fatty acids. These fatty acids may function as precursors to milk fat. Part of the acetate may be transferred with the blood circulation to the mammary gland, where the acetate may be used for the synthesis of fatty acids having generally sixteen or fewer carbon. Butyric acid may also be used as a precursor of milk fat.

Cell energy in the form of adenosine triphosphate (ATP) is generated in the mitochondria, and cells of the mammary gland contain dozens of mitochondria. An intermediate product in ATP formation, active acetic acid (acetyl-CoA), is generally obtained from carbohydrates and fats. However, in case of lack of energy, acetyl-CoA also may be obtained from carbon chains of proteins, a process which is not economical. A ruminant does not use much glucose to produce acetyl-CoA, but instead used acetate. The main source of acetyl-CoA in ruminants, in addition to the acetic acid formed in the rumen, is the β-oxidation of fatty acids. Acetate is partly derived from the β-oxidation of fatty acids, and the fatty acid palmitic acid provides a significant role in forming of the acetate.

It has been determined that saturated fatty acids, when included as a component of feed, may be surprisingly suitable for producing acetic acid and also acetyl-CoA. Saturated fatty acids, that may include but are not limited to, palmitic acid, stearic acid, and myristic acid, may therefore be an important source of energy. For example, if the eight acetyl-CoAs produced from palmitic acid are used for complete oxidation in the citric acid cycle, 129 ATP molecules may be obtained from one palmitic acid molecule.

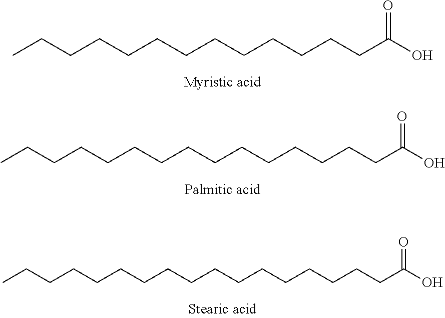 [SMILES: CCCCCCCCCCCCCC(=O)O ; CCCCCCCCCCCCCCCC(=O)O ; CCCCCCCCCCCCCCCCCC(=O)O]

The amino acids needed for the synthesis of milk protein may be partly obtained from the blood. Non-essential amino acids may be synthesized in the mammary gland using the carbon C2 chain of acetate. However, this process also requires ATP energy. Approximately 30 mmol ATP/1 g protein is needed in this protein synthesis. The energy needed for the synthesis of milk fat varies depending on how the milk fat is formed. In some cases, a portion of the fatty acids may be obtained in de novo synthesis in the mammary gland, or from conversion in the rumen or in the liver. Alternatively or additionally, a portion of the fatty acids may be obtained via the digestive tract from the feed. Further, esterification of fatty acids requires 10.5 mmol ATP per 1 g fat.

When fatty acids are synthesized in the udder (that is, de novo synthesis), about 27 mmol ATP per gram of fat is required. Therefore, more energy may be saved for other purposes if more milk fat components are obtained as fatty acids from the blood circulation rather than having to be produced in the udder. Short and middle-chain fatty acids are obtained only via de novo synthesis, and the long-chain fatty acids (C18 and longer) are obtained only from the blood circulation. Of the milk fatty acids, essentially only palmitic acid can be obtained in both ways.

It has been surprisingly determined that a certain type of nutriment for lactating ruminants can energetically efficiently increase the proportion of milk fat derived from the feed, whereby energy is saved in the mammary gland for the synthesis of protein and lactose. In this manner, milk production may be increased. By configuring a nutriment appropriately, it may be possible to transfer fatty acids, via the digestive tract, into the blood circulation. Therefore, in an embodiment, a feed for ruminants may provide more of the saturated fatty acids to the blood. Such a feed may be a feed particle that includes a nutritional component and a coating on at least a portion of the feed particle, wherein the coating includes a saturated fatty acid component. In an embodiment, the saturated fatty acid component may be at least about 3 weight percent of the feed to about 75 weight percent of the feed. In embodiments, the weight percent of the saturated fatty acid component may be about 3, about 5, about 10, about 15, about 20, about 25, about 30, about 35, about 40, about 45, about 50, about 55, about 60, about 65, about 70, about 75, or any value or range of values between any two of the listed values (including endpoints). As an example, the weight percent of the saturated fatty acid component in the coating may be about 10 wt % to about 40 wt %.

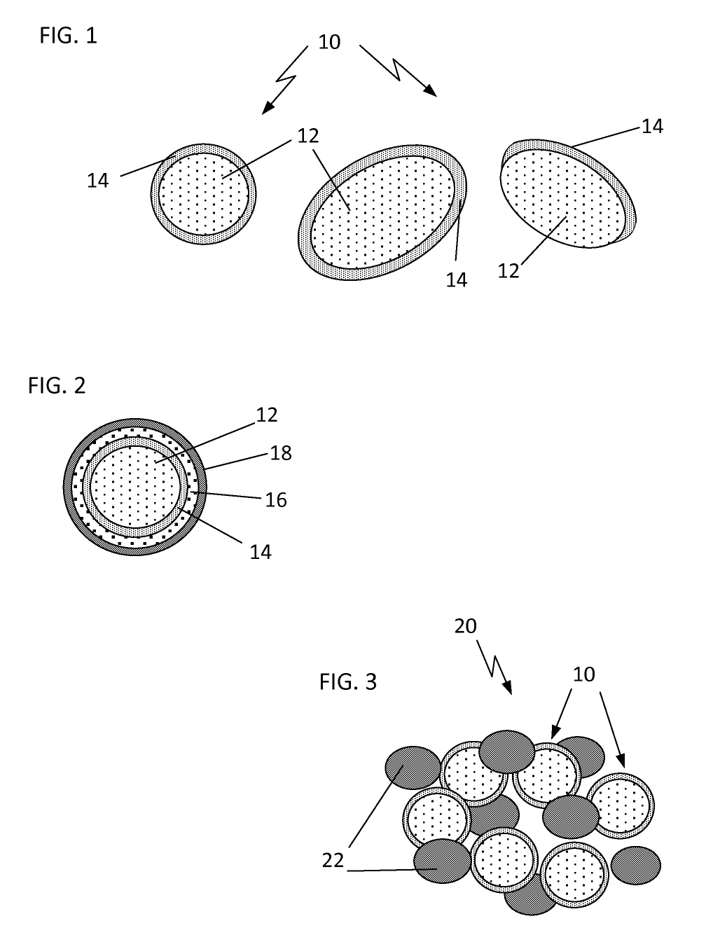

FIG. 1 provides several alternative cross-sectional depictions of feed particles 10. As non-limiting examples, feed particles 10 may include a nutritional portion 12 and a coating 14 that may partially or fully cover the exterior surface of the nutritional component.

In an embodiment, at least about 70 weight percent of the coating 14 may be provided by at least one saturated fatty acid component. In various embodiments, the weight percent of the at least one saturated fatty acid component in the coating 14 may be about 70%, about 75%, about 80%, about 85%, about 90%, about 95%, about 100%, or any value or range between any two of the listed values (including endpoints). In various embodiments, the coating 14 may include additional materials, such as starch, for example, that may help solidify, or stabilize the coating once applied to the nutritional component. Additional coating materials that may be used for coating 14 may include poly vinyl acetate, carboxy methyl cellulose, polyvinyl acetate phthalate (PVAP), or a combination of any of the mentioned coating materials.

In an embodiment, all of the saturated fatty acid in the feed particle 10 may be contained in the coating 14, and the nutritional component 12 of the feed particle may therefore not contain any saturated fatty acid.

In an embodiment, a coating 14 may include a saturated fatty acid component that may have a melting temperature of at least about 60° C. The saturated fatty acid component may include at least one saturated fatty acid moiety having a melting temperature of about 60° C. to about 80° C. In embodiments, a saturated fatty acid component may be chosen that has a melting temperature of about 60° C., about 62° C., about 64° C., about 66° C., about 68° C., about 70° C., about 72° C., about 74° C., about 76° C., about 78° C., about 80° C., or any value or range between any two of the listed values (including endpoints).

In an embodiment, for example, the saturated fatty acid component may include a moiety of palmitic acid. Moieties of palmitic acid may include, but are not limited to, palmitic acid, palmitic acid derivatives, and any combination thereof. Some examples of palmitic acid derivatives may include, but are not limited to, palmitic acid esters, palmitic acid phosphonates, palmitic acid amides, palmitic acid salts, palmitic acid carbonates, palmitic acid carbamates, palmitic acid imides, palmitic acid anhydrides, and any combination thereof.

The saturated fatty acid component may include free palmitic acid, and in an embodiment, the saturated fatty acid component may include at least about 70 weight percent of the free palmitic acid. In various embodiments, where the saturated fatty acid component includes free palmitic acid, the weight percent of free palmitic acid in the saturated fatty acid component may be about 70%, about 75%, about 80%, about 85%, about 90%, about 95%, about 100%, or any value or range between any two of the listed values (including endpoints). In one configuration, a feed particle may include a nutritional component and a coating on at least a portion of the feed particle. The coating may include a saturated fatty acid component that includes at least about 90 weight percent of free palmitic acid.

In one configuration, the coating may be about 100% saturated fatty acid component, and the saturated fatty acid component may be about 100% free palmitic acid so that the coating may be composed of essentially about 100% free palmitic aid, or alternatively, may be composed of 100% free palmitic acid.

The saturated fatty acid component may include at most about 30 weight percent free stearic acid. In various embodiments, wherein the saturated fatty acid component includes free stearic acid, the weight percent of free stearic acid in the saturated fatty acid component may be about 30%, about 25%, about 20%, about 15%, about 10%, about 5%, about 0%, or any value or range between any two of the listed values (including endpoints).

In various embodiments, the saturated fatty acid component may include essentially only free palmitic acid and free stearic acid. Various ratios by weight of palmitic acid to stearic acid may include about 70:30, about 75:25, about 80:20, about 85:15, about 90:10, about 95:5, about 100:0, or any value or range between any two of the listed values (including endpoints).

As shown in FIG. 2, additional layers 16, 18 of coating materials may be applied over the saturated fatty acid coating 14 to provide a core-shell structure having multiple shells. Some examples of additional coating materials that may be used for coating layers 16, 18 may include enteric coating materials that may provide a pH triggered release, such as cellulose acetate trimellitate, sodium alginate, methyl acrylate-methacrylic acid copolymers, methyl methacrylate-methacrylic acid copolymers, cellulose acetate succinate, polyvinyl acetate phthalate, or coating materials that may provide for sustained delivery, such as polylactic acid, polyglycolic acid, chitosan or combinations thereof.

The nutritional component 12, as represented in FIG. 1, may include one or more of carbohydrate sources, protein sources, amino acids or derivatives, vitamins, minerals, glycogenic precursors, and antioxidants. Feed compositions may also include auxiliary agents that may include pelletizing agents, such as lignin sulphates and/or colloidal clay. In embodiments, the nutritional component may be a wood particle, a hay particle, a grain particle, a protein particle, a yeast particle, and any combination thereof.

Some examples of carbohydrate sources may include, but are not limited to, sugar beet pulps, sugar canes, wheat bran, oat hulls, grain hulls, soybean hulls, peanut hulls, wood, brewery byproduct, forages, roughages, sugars, starch, cellulose, hemicellulose, and grain sources, including wheat, corn, oats, sorghum, millet, and barley. These carbohydrates may be used independently or in combination. In embodiments, the carbohydrate content of the mixture may be about 0.1 wt % to about 50 wt %, about 5 wt % to about 40 wt %, about 5 wt % to about 35 wt %, or about 5 wt % to about 20 wt %. Specific examples of carbohydrate content include about 0.1 wt %, about 1 wt %, about 5 wt %, about 10 wt %, about 20 wt %, about 30 wt %, about 40 wt %, about 50 wt %, and ranges between any two of these values (including endpoints).

Some examples of protein sources may include, but are not limited to, soybean, canola (rapeseed), cottonseed, corn gluten meal, oilseed meals such as palm oil, animal by-product meals such as meat meal, poultry meal, blood meal, feather meal, and fish meal, plant by-product meals such as wheat middlings, soybean hulls and corn by-products, and microbial protein such as torula yeast and brewer's yeast. These protein sources may be used independently or in combination. In various embodiments, the protein content of the feed may be about 0.1 wt % to about 55 wt %, about 5 wt % to about 45 wt %, or about 8 wt % to about 40 wt %. Specific examples of protein content include about 0.1 wt %, about 1 wt %, about 5 wt %, about 10 wt %, about 20 wt %, about 30 wt %, about 40 wt %, about 50 wt %, and ranges between any two of these values (including endpoints).

Some examples of amino acid sources, may include, but are not limited to, essential amino acids, nonessential amino acids, common amino acids, uncommon amino acids, and derivatives of any of the amino acids. Additional examples may include, but are not limited to, leucine, lysine, histidine, valine, arginine, threonine, isoleucine, phenylalanine, methionine, tryptophan, and their protected forms and derivatives. These amino acid sources may be used independently or in combination.

Some examples of vitamins, may include, but are not limited to, vitamin A, vitamin D, vitamin E, vitamin B1, vitamin B2, pantothenic acid, niacin, biotin, choline, carnitine, and any combination thereof.

Some examples of minerals may include, but are not limited to, ions of calcium, sodium, magnesium, phosphorous, and potassium and trace elements manganese, zinc, selenium, copper, iodine, iron, cobalt and molybdenum. These minerals and trace elements may be provided using any of a number of mineral sources. In general, any GRAS (generally recognized as safe) mineral source may be used which provides a bioavailable mineral. Table 1 below provides some examples of suitable mineral sources.

TABLE 1
GRAS Mineral Sources

| | | | |
|---|---|---|---|
| Calcium Acetate | Calcium Carbonate | Calcium Chloride | Calcium Gluconate |
| Calcium Hydroxide | Calcium Iodate | Calcium Iodobehenate | Calcium Oxide |
| Calcium Sulfate | Cobalt Acetate | Cobalt Carbonate | Cobalt Chloride |
| (anhydrous or | | | |
| dihydrate) | | | |
| Cobalt Oxide | Cobalt Sulfate | Dicalcium Phosphate | Magnesium Acetate |
| Magnesium Carbonate | Magnesium Oxide | Magnesium Sulfate | Manganese Carbonate |
| Manganese Chloride | Manganese Citrate | Manganese Gluconate | Manganese |
| | (soluble) | | Orthophosphate |
| Manganese Oxide | Manganese Phosphate | Manganese Sulfate | Monocalcium Phosphate |
| | (dibasic) | | |
| Monosodium Phosphate | Potassium Acetate | Potassium Bicarbonate | Potassium Carbonate |
| Potassium chloride | Potassium Iodate | Potassium Iodide | Potassium Sulfate |
| Sodium Acetate | Sodium Chloride | Sodium Bicarbonate | Disodium Phosphate |
| Iron Ammonium Citrate | Iron Carbonate | Iron Chloride | Iron Gluconate |
| Iron Oxide | Iron Phosphate | Iron Pyrophosphate | Iron Sulfate |
| Reduced Iron | Sodium Iodate | Sodium Iodide | Sodium Tripolyphosphate |
| Sodium Sulfate | Tricalcium Phosphate | Zinc Acetate | Zinc Carbonate |
| Zinc Chloride | Zinc Oxide | Zinc Sulfate | Copper Sulfate |
| Sodium Selenite | Selenium Yeast | | |

Some examples of glucogenic precursor may include, but are not limited to, glycerol, propylene glycol, molasses, propionate, glycerine, propane diol, calcium propionate, and any combination thereof.

Some examples of antioxidants may include, but are not limited to, gallic acid, protochatechuic acid, p-coumaric acid, carnosic acid, caffeic acid, rosmarinic acid, vitamin C, vitamin E, ascorbyl palmitate, propyl gallate, resveratrol, selenium, eugenol, carvacrol, safrole, thymol, menthol, 1,8-cineole, α-terpineol, p-cymene, cinnamaldehyde, myristicin, piperine, epicatechin, quercetin, epicatechin gallate, epigallocatechin gallate, rutin, chalcone, flavone, flavanol, anthocyanin, anthocyanidin-3,5-glycoside, carnosol, rosmanol, S-allyl (D, L) cysteine sulfoxide, diallyl sulfide, allyl trisulfide, allyl-cysteine hesperitin, naringin, neohesperidin, hesperidin, and any combination thereof.

As represented in FIG. 3, a ruminant feed 20 may include at least one additional feed ingredient 22 mixed with the coated food particle 10. In embodiments, the at least one additional feed ingredient may include sugar beet pulp, sugar cane, wheat bran, oat hull, grain hulls, soybean hulls, peanut hulls, wood, brewery byproduct, forages, roughages, sugars, starch, cellulose, hemicellulose, wheat, corn, oats, sorghum, millet, barley, oilseed meal, soy meal, bean meal, rapeseed meal, sunflower meal, coconut meal, olive meal, linseed meal, grapeseed meal, glycogenic precursors, vitamins, minerals, amino acids, amino acid derivatives, and any combination thereof.

A feed, such as feed 20, may be configured to contain at most about five weight percent trans fatty acid. For example, the amount of trans fatty acid in the feed may be about 5 weight %, about 4 weight %, about 3 weight %, about 2 weight %, about 1 weight %, or any value or range between any two of the listed values (including endpoints). Alternatively, the feed may contain substantially no trans fatty acid. For example, substantially no trans fatty acid may be less than about 1% trans fatty acid, or less than about 0.5 weight % trans fatty acid, or less than about 0.1 weight % trans fatty acid. In an embodiment, the feed may contain no trans fatty acid.

The ruminant feed 20 may be configured as a Total Mixed Ration (TMR) feed formulated to contain a specific nutrient content per ration. In a TMR feed, all the feed ingredients (forage, grain, supplement, minerals, and vitamins) are mixed together in a nutritionally balanced ration that is then fed to the animal, rather than each ingredient being fed individually. As such, the TMR prevents the ruminant from self-determining the amount of each component that they eat. The feed particles 10 may be included as a component of the TMR feed, and the feed may include at least one additional feed ingredient 22 blended with the coated feed particle 10.

The feed may be in the form of feed pellets that are formed from a plurality of the coated feed particles. In an embodiment, the feed pellets may include at least about 10 weight percent of the saturated fatty acid component. The saturated fatty acid component may include at least about 70 weight percent free palmitic acid. In addition, the feed pellets may contain up to about 5 weight percent trans fatty acid.

In an embodiment, the feed pellets may include at least about 10 weight percent of the saturated fatty acid component, and the saturated fatty acid component may include at least about 90 weight percent free palmitic acid. The nutritional component 12 of the feed particles 10 in the pellets may be wood particles, hay particles, grain particles, protein particles, yeast particles, and any combination thereof. The nutritional component 12 may include at least one carbohydrate source, at least one protein source, at least one amino acid, at least one amino acid derivative, at least one vitamin, at least one mineral, at least one glycogenic precursor, at least one antioxidant, and any combination thereof. In an embodiment, the feed pellets may contain substantially no trans fatty acid. In an embodiment, the feed pellets may include at least one additional feed ingredient selected from sugar beet pulp, sugar cane, wheat bran, oat hull, grain hulls, soybean hulls, peanut hulls, wood, brewery byproduct, forages, roughages, sugars, starch, cellulose, hemicellulose, wheat, corn, oats, sorghum, millet, barley, oilseed meal, soy meal, bean meal, rapeseed meal, sunflower meal, coconut meal, olive meal, linseed meal, grapeseed meal, glycogenic precursors, vitamins, minerals, amino acids, amino acid derivatives, and any combination thereof.

In embodiments, a ruminant feed with coated feed particles may have a constitution that includes:
total lipids that may be in an amount of about 10.1 wt % to about 57 wt %, or about 10.5 wt % to about 45 wt %, or about 10.5 wt % to about 40 wt %, or about 10.5 wt % to about 30 wt %, or about 10.5 wt % to about 20 wt %, or about 11 wt % to about 14 wt %;
free palmitic acid that may be in an amount of about 10.1 wt % to about 50 wt %, or about 10.1 wt % to about 35 wt %, or about 10.1 wt % to about 25 wt %;
proteins that may be in an amount of about 15 wt % to about 50 wt %, or about 16 wt % to about 40 wt %, or about 17 wt % to about 35 wt %; and
starch in an amount of about 4 wt % to about 50 wt %, or about 6 wt % to about 45 wt %, or about 8 wt % to about 40 wt %, or about 12 wt % to about 35 wt %; and
   the amount of free palmitic acid may be at least about 40 wt %, or at least about 45 wt %, or at least about 50 wt %, or at least about 55 wt %, or at least about 60 wt %, or at least about 65 wt %, or at least about 70 wt %, or at least about 75 wt %, or at least about 80 wt %, or at least about 85 wt %, or at least about 90 wt % of the total lipids.

Ruminant feed particles or compositions as described above that contain a high percentage of saturated fatty acid allow for the transfer of palmitic acid from the feed via the digestive tract into the blood circulation, thus improving the energy efficiency in milk production of a ruminant. When the utilization of energy becomes more effective, milk production increases and the concentrations of protein and fat in the milk rise, while the proportion of trans fatty acids in the milk may be lowered. The amount of saturated fatty acids remains approximately the same but the proportion of palmitic acid is increased.

The feed enhances fat synthesis in the mammary gland by bringing milk fat components to the cell. As such, the energy consuming synthesis in the mammary gland as described above is not necessary. As a result, glucose can more efficiently be used for lactose production leading to an increase in milk production. In addition, the milk protein content may rise because glucose need not be produced from amino acids. The ruminant (e.g. cow) therefore does not lose weight at the beginning of the lactation period, which can reduce fertilization issues. Thus, the problem with low fertility also decreases. In addition, since part of the easily digestible nutrients can pass directly by the rumen undigested, methane formation can be decreased which improves utilization of nutrients.

A method for increasing at least one of an amount of milk produced by a lactating ruminant and a milk fat content in the milk produced by the lactating ruminant may therefore include feeding the lactating ruminant a feed particle that includes a nutritional component and a coating on at least a portion of the feed particle, wherein the coating includes a saturated fatty acid component. In an embodiment, the feeding of feed particles to a lactating ruminant may include feeding the lactating ruminant feed particles that may be completely coated with the coating. The coating may include a palmitic acid moiety, and in various embodiments, the palmitic acid moiety may include palmitic acid, a palmitic acid derivative, and any combination thereof. As previously provided, the palmitic acid derivative may include a palmitic acid ester, a palmitic acid phosphonate, a palmitic acid amide, a palmitic acid salt, a palmitic acid carbonate, a palmitic acid carbamate, a palmitic acid imide, a palmitic acid anhydride, and any combination thereof.

In an embodiment, the lactating ruminant may be fed a feed particle that has a coating that includes free palmitic acid. In an embodiment, the coating may include at least about 70 weight percent free palmitic acid. In an embodiment, the coating may include at least about 90 weight percent free palmitic acid. In a further embodiment, the coating may be 100 weight percent free palmitic acid.

The amount of free palmitic acid that may be included in a coating on the feed particle may be pre-determined so that the amount of feed provided to the lactating ruminants provides about 200 g to about 1000 g of free palmitic acid per day. In various embodiments, the daily amount of free palmitic acid fed to a ruminant may be about 200 g, about 250 g, about 300 g, about 350 g, about 400 g, about 450 g, about 500 g, about 550 g, about 600 g, about 650 g, about 700 g, about 750 g, about 800 g, about 850 g, about 900 g, about 950 g, about 1000 g, or any value or range between any two of the listed values (including endpoints).

Alternatively, the amount of free palmitic acid provided to a lactating ruminant may be based on the average amount of milk that the ruminant produces per day. A feeding method may therefore include determining an average amount of milk produced per day for the lactating ruminant, and providing to the lactating ruminant a feed configured so that the feed particles provide the lactating ruminant with a daily amount of about 5 g to about 15 g free palmitic acid per kg milk produced per day. In various embodiments, the daily amount of free palmitic acid provided to the lactating ruminants per kg milk produced per day may be about 5 g, about 6 g, about 7 g, about 8 g, about 9 g, about 10 g, about 11 g, about 12 g, about 13 g, about 14 g, about 15 g, or any value or range between any two of the listed values (including endpoints).

By providing lactating ruminants with a feed particle configured in accordance with the above embodiments, at least one of the following may be achieved as compared to a similar ruminant not provided the coated feed particle: an increase of at least about 1% in the production of milk by the ruminant, and an increase of at least about 10% in the milk fat content in the milk produced by the ruminant.

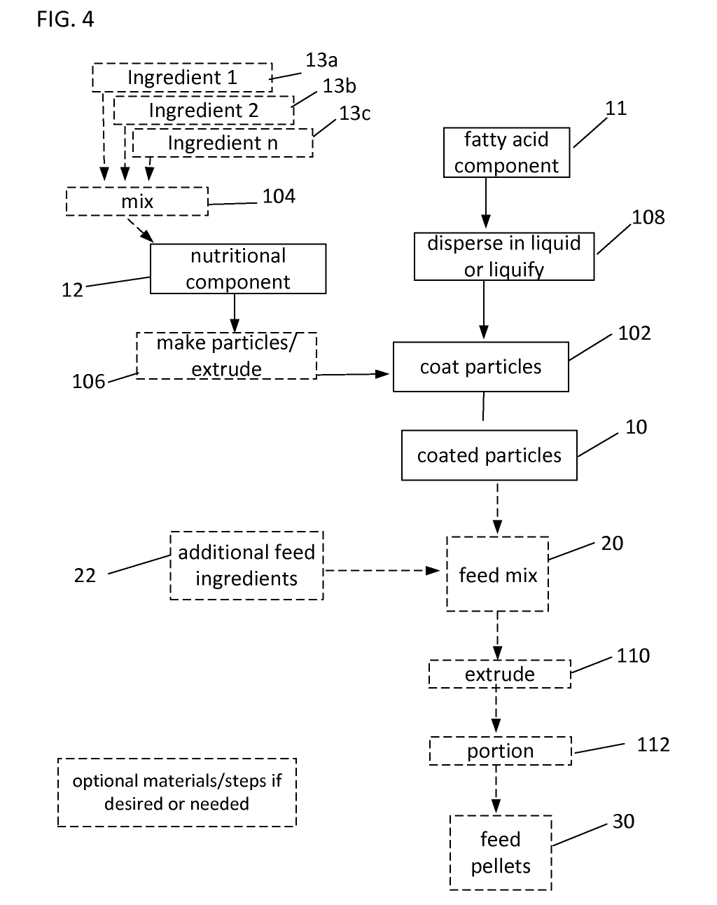

As generally represented in FIG. 4, a coated feed particle 10 as represented in FIG. 1, may be produced by a method that includes coating 102 at least a portion of a nutritional feed component 12 with a coating material 14 that includes a saturated fatty acid component 11. In an embodiment, the method may include completely coating the nutritional feed component 12 with the coating material 14.

A desired formulation of the nutritional component 12 may be determined and the appropriate ingredients, represented as ingredient 1 13a, ingredient 2 13b, and ingredient n 13c, may be mixed together 104. The mixture may be formed or portioned 106 into particles, such as by extrusion or pelletizing, and the particles may be coated 102 with the coating material 14. In an embodiment, the coating material 14 may include a fatty acid component 11, and the fatty acid component may be liquefied 108, for example, by melting, or the coating material may be dispersed in a liquid emulsion. In embodiments in which the coating material is applied in liquid form, the coating material 14 may be sprayed onto the particles of feed mixture. The method may include coating the nutritional feed component 12 by spraying a liquefied fatty acid component, a fatty acid emulsion, and any combination thereof onto the particles of the nutritional component.

In an embodiment, particles may be dispersed onto a grate, a screen, or a similar material providing access to one or more sides of the particles, and the coating material may be sprayed 102 onto the particles. Alternatively, the particles may be sprayed as the particles fall from an upper conveyor, through a spray of coating material, and onto a lower conveyor. The particles may also be dispersed onto a rotating disc while being sprayed. In an embodiment, the disc may be heated to maintain the temperature above the melting temperature while being sprayed. Other types of coating methods may also be used, for example, immersion of the particles into a liquid coating material.

The method may include coating 102 the nutritional feed component 12 with a coating material 14 that includes a saturated fatty acid component 11 having a melting temperature of at least about 60° C. Such fatty acid components 11 may be liquefied 208 by heating to a temperature equal to or greater than the melting temperature. As an example, a coating material 14 that includes at least one palmitic acid moiety may be coated onto the nutritional component 12. As previously discussed, the palmitic acid moiety may include palmitic acid, a palmitic acid derivative, and any combination thereof. Some examples of palmitic acid derivatives may include a palmitic acid ester, a palmitic acid phosphonate, a palmitic acid amide, a palmitic acid salt, a palmitic acid carbonate, a palmitic acid carbamate, a palmitic acid imide, a palmitic acid anhydride, and any combination thereof.

In an embodiment, coating 102 the nutritional feed component 12 may include coating the nutritional feed component with a coating material 14 that includes free palmitic acid. The coating material 14 may include at least about 90 weight percent free palmitic acid. Alternatively, coating 102 the nutritional feed component 12 may include coating the nutritional feed component with a coating material 14 that includes free palmitic acid and at most about 30 weight percent of free stearic acid. In addition to any saturated fatty acids, the coating material 14 may also contain starch.

The coated feed particles may be mixed with additional feed ingredients 22 to provide an animal feed 20. The feed mix 20 may be pelleted or extruded 110 and portioned 112 into feed pellets 30, or mixed into a TMR feed to provide a feed composition. The total amount of the saturated fatty acid component in the feed composition may be at least about 3% by weight, or alternatively at least about 10% by weight.

### EXAMPLES

### Example 1: Coated Feed Particles

A nutritional feed particle of about 20 wt % palmitic acid, 19 wt % other lipids, 37 wt % protein, 21 wt % starch, 3 wt % other ingredients (vitamins, minerals, etc.) will be produced. The palmitic acid will be provided as a coating on the particles.

### Example 2: Method for Producing Coated Feed Particles

Coated feed particles as described in Example 1 will be produced. Pre-determined amounts of feed grain (wheat, barley, oats), sugar beet pulp, wheat bran, molasses, protein crush (rapeseed, soya), wheat middlings, minerals, premixes (vitamins, mineral nutrients), propylene glycol, glycerol/sodium propionate, amino acid mixture, B vitamin mixture, and carnitine will be combined to form a nutritional component that contains about 24 wt % lipids, about 46 wt % protein, about 26 wt % starch, and about 4 wt % other ingredients. The ingredients will be processed, thoroughly mixed, and extruded to form particles.

A coating of 100% free palmitic acid will be applied to the particles. Free palmitic acid will be warmed to a temperature of about 65° C. to melt the palmitic acid and form a liquid. The nutritional feed particles will be conveyed through a spraying station where they will be sprayed with the palmitic acid. The palmitic acid will cool and solidify upon contact with the particles to form a coating of palmitic acid on the particles. The amount of palmitic acid applied will be configured so that the total amount of palmitic acid is about 20 wt % of the particles.

### Example 3: Two-Month Study Confirming Efficacy of Coated Feed Particles in Dairy Cow Feed

A feeding experiment will be performed for about two months where a conventional complete feed will be replaced by a feed having the following composition (% by weight):

| | |
|---|---|
| Sugar beet pulp | 20 |
| Barley | 20 |
| Palmitic acid | 20 (as a coating on particles of Example 1) |
| Wheat bran | 14 |
| Oat bran | 10 |
| Propylene glycol | 10 |
| Molasses | 2 |
| Sodium bicarbonate | 2 |
| Biotin | 1 |
| Carnitine premix | 0.5 |
| Methionine premix | 0.5 |

The above test feed will be given to one set of cows, and a standard conventional complete feed will be given to a second set of cows as a reference. Based on the following results that were obtained for a test feed with non-covalently bonded palmitic acid in comparison to a reference feed:

| | Reference | Test feed |
|---|---|---|
| Milk kg/d | 29.5 | 32.5 |
| Fat wt % | 3.98 | 4.43 |
| Protein wt % | 3.15 | 3.37 |

Expected results for a feed with the formulation as provided above will show that the milk production as well as fat and protein concentrations increased significantly. In addition, the degree of feed utilization, measured as the efficiency of utilization of metabolizable energy intake for milk production (kl), will also significantly improve.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A feed composition for ruminants, the feed composition comprising:
a feed particle comprising a nutritional component; and
a coating on at least a portion of the feed particle, wherein the coating comprises a saturated fatty acid component.

2-6. (canceled)

7. The feed composition of claim 1, wherein the saturated fatty acid component comprises free palmitic acid.

8. The feed composition of claim 7, wherein the saturated fatty acid component comprises at least about 90 weight percent of the free palmitic acid.

9-10. (canceled)

11. The feed composition of claim 1, wherein the coating consists essentially of free palmitic acid.

12-13. (canceled)

14. The feed composition of claim 1, wherein the nutritional component comprises a carbohydrate component, a protein component, an amino acid component, a vitamin, a mineral, a glycogenic precursor, an antioxidant, and any combination thereof.

15-22. (canceled)

23. The feed composition of claim 1, wherein the coating further comprises starch.

24. The feed composition of claim 1, wherein the feed particle additionally comprises a second coating.

25. The feed composition of claim 24, wherein the second coating is disposed over the coating comprising the at least one saturated fatty acid, and the second coating comprises an enteric coating material, a sustained release coating material or a combination thereof.

26. The feed composition of claim 1, wherein:
the feed composition further comprises at least one additional feed ingredient mixed with the coated food particle; and
the feed composition comprises at least about 3 weight percent of the saturated fatty acid component.

27-31. (canceled)

32. The feed composition of claim 1, wherein the feed composition is a total mixed ration feed composition formulated to contain a specific nutrient content per ration, and the feed composition further comprises at least one additional feed ingredient blended with the coated feed particle.

33-38. (canceled)

39. The feed composition of claim 32, wherein:
the feed composition comprises at least about 10 weight percent of the saturated fatty acid component and contains substantially no trans fatty acid; and
the saturated fatty acid component comprises at least about 90 weight percent free palmitic acid.

40. The feed composition of claim 1, wherein the feed composition is in the form of feed pellets comprising a plurality of the coated feed particles.

41. The feed composition of claim 40, wherein the feed pellets comprise at least about 10 weight percent of the saturated fatty acid component.

42-63. (canceled)

64. A method for increasing at least one of an amount of milk produced by a lactating ruminant and a milk fat content in the milk produced by the lactating ruminant, the method comprising feeding the lactating ruminant a feed particle comprising a nutritional component and a coating on at least a portion of the feed particle, wherein the coating comprises a saturated fatty acid component.

65-68. (canceled)

69. The method of claim 64, wherein feeding the lactating ruminant comprises feeding the lactating ruminant a feed particle comprising a coating comprising free palmitic acid.

70. (canceled)

71. The method of claim 64, wherein feeding the lactating ruminant comprises providing to the lactating ruminant an amount of the feed particle to provide the lactating ruminant with a daily amount of about 0.2 kg to about 1 kg of the free palmitic acid.

72. The method of claim 64, wherein feeding the lactating ruminant comprises:
determining an average amount of milk produced per day for the lactating ruminant; and
providing to the lactating ruminant an amount of the feed particle to provide the lactating ruminant with a daily amount of about 5 g to about 15 g free palmitic acid per kg milk produced per day.

73-78. (canceled)

79. The method of claim 64, wherein feeding the lactating ruminant comprises feeding the lactating ruminant a feed particle comprising a coating consisting essentially of free palmitic acid.

80-82. (canceled)

83. The method of claim 64, wherein providing the feed particle to the ruminant results in at least one of an at least about 1% increase in production of milk by the ruminant, and an at least about 10% increase in the milk fat content in the milk produced by the ruminant, as compared to a similar ruminant not provided the feed particle.
